(19) United States
(12) Patent Application Publication
(10) Pub. No.: US 2026/0110365 A1
(43) Pub. Date: Apr. 23, 2026

(54) FLOW PATH SWITCHING DEVICE

(71) Applicant: AISAN KOGYO KABUSHIKI KAISHA, Obu-shi, Aichi (JP)

(72) Inventors: Mamoru YOSHIOKA, Susono-shi (JP); Shinji KAWAI, Gifu-shi (JP)

(73) Assignee: AISAN KOGYO KABUSHIKI KAISHA, Obu-shi, Aichi (JP)

(21) Appl. No.: 19/115,411

(22) PCT Filed: Sep. 8, 2023
(86) PCT No.: PCT/JP2023/032875

§ 371 Date: Mar. 26, 2025

(30) Foreign Application Priority Data
Oct. 25, 2022 (JP) 2022-170578

(51) Int. Cl. F16K 11/074

(52) U.S. Cl. CPC F16K 11/074

(57) ABSTRACT

This flow path switching device is provided with, as communication paths: an adjacent-port communication path for allowing communication between a port of a first fixed member and a port of a second fixed member, the ports being provided at positions adjacent to each other in the circumferential direction of a rotary member when viewed in the axial direction of the rotary member; and an opposite-port communication path for allowing communication between the port of the first fixed member and the port of the second fixed member, the ports being provided at positions opposite each other in the radial direction of the rotary member when viewed in the axial direction of the rotary member.

### TECHNICAL FIELD

The disclosure relates to a flow path switching device for switching flow path patterns through which a fluid flows.

### BACKGROUND ART

Patent Document 1 discloses a valve for switching ports to be communicated by rotating a main valve body.

RELATED ART DOCUMENTS

### Patent Documents

Patent Document 1: Japanese unexamined patent application publication No. 2019-49364

### SUMMARY OF INVENTION

### Problems To Be Solved By The Invention

Patent Document 1 discloses only a flow path pattern for allowing communication between ports arranged in a circumferential direction of the valve main body when the main valve body is placed in a second rotation position. This valve disclosed in Patent Document 1 has less switchable flow path patterns.

Then, the present disclosure has been made to solve the above problems and has a purpose to provide a flow path switching device capable of switching between many flow path patterns.

### Means Of Solving The Problems

To achieve the above-mentioned purpose, one aspect of the present disclosure provides a flow path switching device comprising: a first fixed member; a second fixed member; and a rotary member having a circular plate shape and provided between the first fixed member and the second fixed member, the first fixed member including a plurality of ports and the second fixed member including a plurality of ports, the rotary member being provided with a communication path to allow communication between the ports of the first fixed member and the ports of the second fixed member, the rotary member being rotated about a central axis of the circular plate shape to switch combinations of the ports of the first fixed member and the ports of the second fixed member, which are communicated through the communication path, to switch a flow path pattern through which a fluid flows, wherein the communication path includes: an adjacent-port communication path for allowing communication between the port of the first fixed member and the port of the second fixed member, the ports being provided at positions adjacent to each other in a circumferential direction of the rotary member when viewed in an axial direction of the rotary member; and an opposite-port communication path for allowing communication between the port of the first fixed member and the port of the second fixed member, the ports being provided at positions opposite each other in a radial direction of the rotary member when viewed in the axial direction of the rotary member.

According to this configuration, since it is possible to switch to a flow path pattern formed by the opposite-port communication path in addition to a flow path pattern formed by the adjacent-port communication path, the number of switchable flow path patterns can be increased. This configuration allows switching to many flow path patterns.

In the above-described configuration, preferably, the opposite-port communication path includes a plurality of opposite-port communication paths that are provided in different positions from each other in the axial direction of the rotary member, while intersecting with each other in the radial direction of the rotary member.

According to this configuration, the plurality of opposite-port communication paths can be placed so as not to interfere with each other in the axial direction of the rotary member. Thus, the flow path patterns using the plurality of opposite-port communication paths can be formed.

In the above-described configuration, preferably, the opposite-port communication path includes a plurality of opposite-port communication paths that are inclined without interfering with each other in the axial direction of the rotary member, while intersecting with each other in the radial direction of the rotary member.

According to this configuration, the flow path patterns can be formed using the plurality of opposite-port communication paths and further the fluid flowing through the opposite-port communication paths is allowed to smoothly flow along the inclination, so that pressure loss of the fluid can be reduced.

In the above-described configuration, preferably, the opposite-port communication paths are each formed in a flat shape extending in the radial direction of the rotary member.

According to this configuration, the width of each opposite-port communication path in the axial direction of the rotary member can be reduced while the flow-path cross-sectional area of each opposite-port communication path can be ensured. This configuration allows for downsizing of the flow path switching device while ensuring the flow rate of a fluid to flow through the opposite-port communication paths.

In the above-described configuration, preferably, the rotary member is composed of a plurality of circular plate members stacked in layers, and each of the plurality of circular plate members is a molded component made of resin, formed with a part of the communication path.

According to this configuration, communication paths of complicated shapes can be easily formed in the rotary member. Thus, the communication paths of various shapes can be realized.

In the above-described configuration, preferably, the ports of the first fixed member and the ports of the second fixed member are provided as three or more ports, the ports of the first fixed member being provided at positions offset from the ports of the second fixed member in a circumferential direction of the rotary member, and the opposite-port communication path is provided as three or more opposite-port communication paths without interfering with each other in the axial direction of the rotary member, while intersecting with each other in the radial direction of the rotary member.

According to this configuration, flow path patterns can be formed using three or more opposite-port communication paths in a six-way or larger valves (e.g., an eight-way valve).

### Effects of the Invention

According to a flow path switching device of the disclosure, many flow path patterns can be switched.

### BRIEF DESCRIPTION OF THE DRAWINGS

FIG. 1 is an external perspective view of a flow path switching device (for a six-way valve) in an embodiment;

FIG. 2 is an exploded perspective view of the flow path switching device in the embodiment (from which a drive unit is omitted);

FIG. 3 is a cross-sectional view of the flow path switching device in the embodiment (from which the drive unit is omitted);

FIG. 4 is a top view of a rotary disk;

FIG. 5 is a top view of a fixed disk;

FIG. 6 is an image diagram of the rotary disk when viewed in its axial direction, which is a diagram showing the positions of rotary-disk communication paths in a first flow path pattern in a first example;

FIG. 7 is a cross-sectional diagram of the rotary disk viewed inward from outside in the radial direction at the position of a dashed-dotted line o in FIG. 6;

FIG. 8 is a top view of a 1^{st}-layer circular plate member;

FIG. 9 is a top view of a 2^{nd}-layer circular plate member;

FIG. 10 is a top view of a 3^{rd}-layer circular plate member;

FIG. 11 is a top view of a 4^{th}-layer circular plate member;

FIG. 12 is a top view of a 5^{th}-layer circular plate member;

FIG. 13 is an image diagram of the rotary member when viewed in its axial direction, which is a diagram showing the positions of rotary-disk communication paths in a second flow path pattern in the first example;

FIG. 14 is a cross-sectional diagram of the rotary disk viewed inward from outside in the radial direction at the position of a dashed-dotted line a in FIG. 13;

FIG. 15 is an image diagram of the rotary disk when viewed in its axial direction, which is a diagram showing the positions of rotary-disk communication paths in a third flow path pattern in the first example;

FIG. 16 is a cross-sectional diagram of the rotary disk when viewed inward from outside in the radial direction at the position of a dashed-dotted line o in FIG. 15;

FIG. 17 is a diagram of a temperature adjusting system in which the flow path switching device is switched to the first flow path pattern;

FIG. 18 is a diagram of a temperature adjusting system in which the flow path switching device is switched to the second flow path pattern;

FIG. 19 is a diagram of a temperature adjusting system in which the flow path switching device is switched to the third flow path pattern;

FIG. 20 is an image diagram of the rotary disk when viewed in its axial direction, which is a diagram showing the positions of rotary-disk communication paths in the second flow path pattern in a second example;

FIG. 21 is a cross-sectional diagram of the rotary disk when viewed inward from outside in the radial direction at the position of a dashed-dotted line a in FIG. 20;

FIG. 22 is a cross-sectional diagram along A-A in FIG. 20;

FIG. 23 is a cross-sectional diagram along B-B in FIG. 20;

FIG. 24 is a cross-sectional diagram along C-C in FIG. 20;

FIG. 25 is a diagram showing an opposite-port communication path in the second example;

FIG. 26 is an image diagram of the rotary disk when viewed in its axial direction, which is a diagram showing the positions of rotary-disk communication paths in the second flow path pattern in a third example; and

FIG. 27 is a cross-sectional diagram of the rotary disk when viewed inward from outside in the radial direction at the position of a dashed-dotted line a in FIG. 26.

### MODE FOR CARRYING OUT THE INVENTION

A flow path switching device 1, which is one example of embodiments of the disclosure, will be described below.

### <Outline of Whole Flow Path Switching Device>

The outline of the whole flow path switching device 1 in this embodiment will be described first.

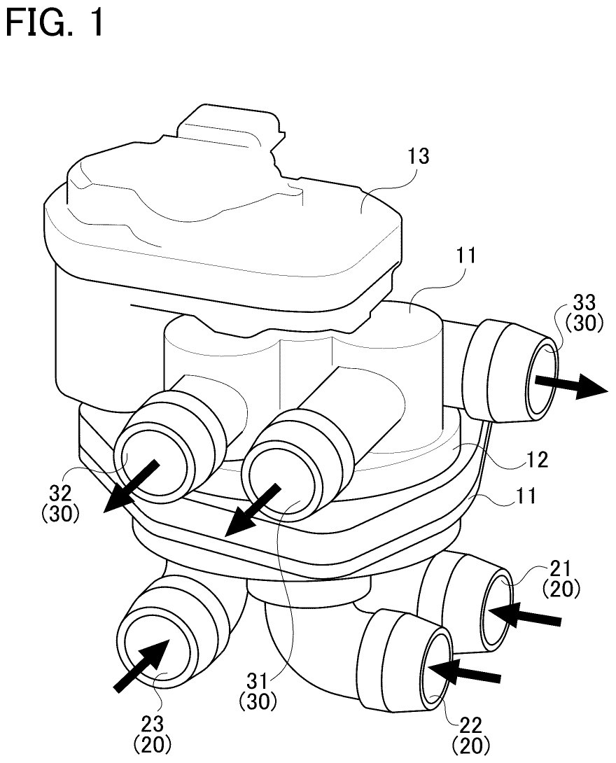

As shown in FIGS. 1 to 3, the flow path switching device 1 includes housings 11, a valve body unit 12, and a drive unit 13.

The housings 11 are provided with inflow ports 20 in which fluid flows, and outflow ports 30 from which fluid flows out. Herein, the flow path switching device 1 is for example a six-way valve, in which the housings 11 include three inflow ports 20 and three outflow ports 30. As the three inflow ports 20, a first inflow port 21, a second inflow port 22, and a third inflow port 23 are provided. Further, as the three outflow ports 30, a first outflow port 31, a second outflow port 32, and a third outflow port 33 are provided.

The housings 11 are made of resin, for example. The housings 11 are one example of a “second fixed member” of the disclosure, and the outflow ports 30 (i.e., the first outflow port 31, second outflow port 32, and third outflow port 33) are one example of a “port of the second fixed member” of the disclosure.

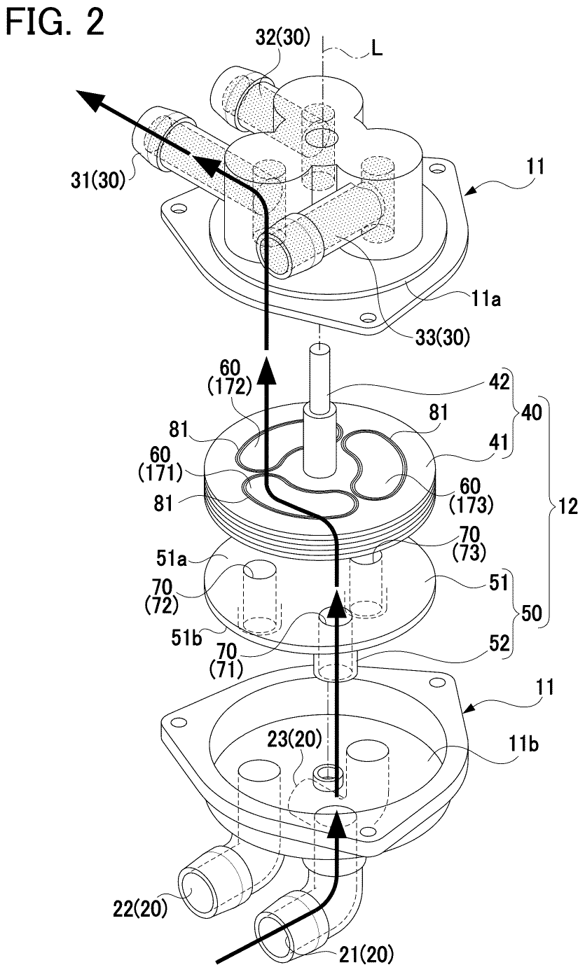

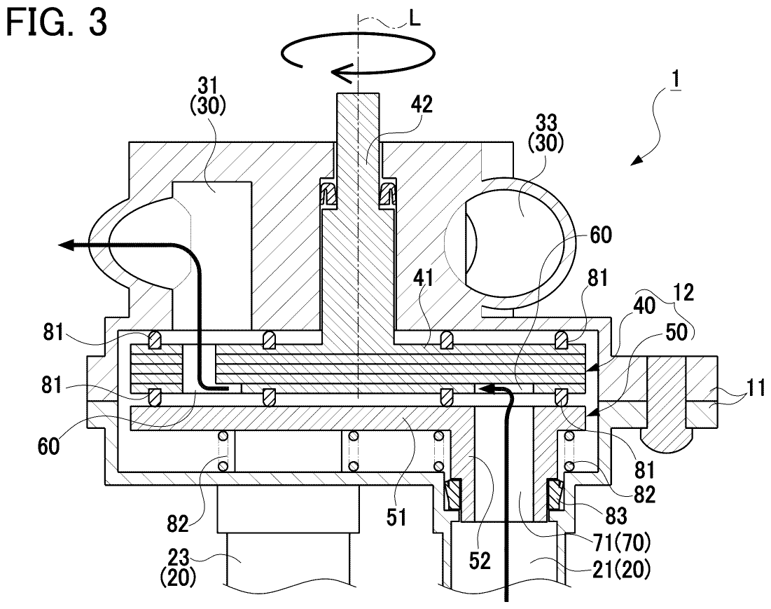

The valve body unit 12 is placed inside the housings 11. This valve body unit 12 is provided with a rotary disk 40, which is rotatable, and a fixed disk 50, as shown in FIGS. 2 and 3. The rotary disk 40 and the fixed disk 50 are placed by being stacked in a direction of the central axis L of a circular plate part 41 of the rotary disk 40 and a circular plate part 51 of the fixed disk 50 (hereinafter, simply referred to as an “axial direction”), which will be described later.

The rotary disk 40 and the fixed disk 50 are made of resin, for example. The rotary disk 40 is one example of a “rotary member” of the disclosure and the fixed disk 50 is one example of the “first fixed member” of the disclosure.

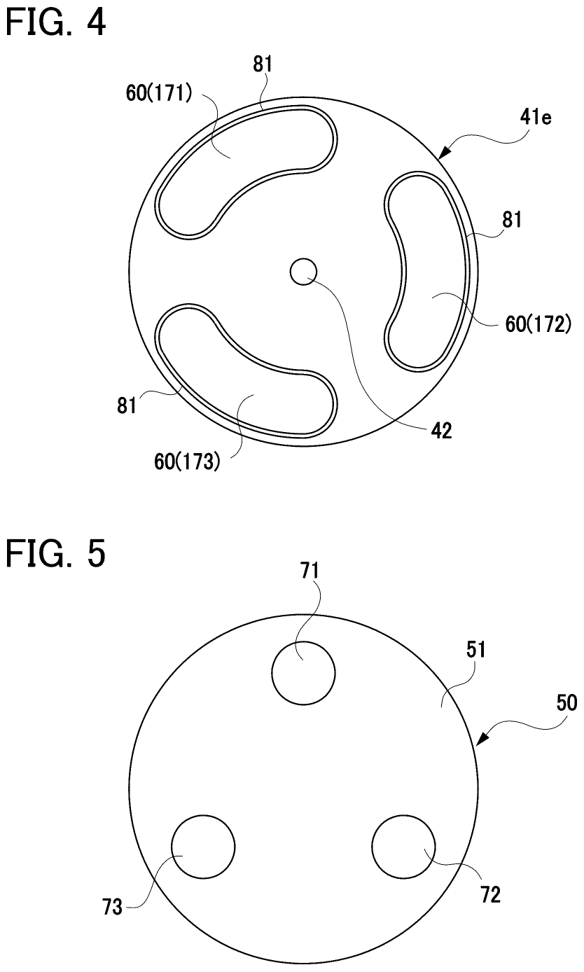

As shown in FIGS. 2 to 4, the rotary disk 40 is provided with the circular plate part 41 and a rotary shaft part 42.

The circular plate part 41 has a circular plate-like shape and is placed between the fixed disk 50 and the housing 11. The circular plate part 41 is provided with rotary-disk communication paths 60 for allowing communication between fixed-disk ports 70 mentioned later and the outflow ports 30. The details of the circular plate part 41 and the rotary-disk communication paths 60 will be described later.

The rotary shaft part 42 is connected, at its one end, to the circular plate part 41 and connected, at its the other end, to the drive unit 13 in the central axis direction. This rotary shaft part 42 is positioned in the center of the circular plate part 41 so that the central axis of the rotary shaft part 42 coincides with the central axis L of the circular plate part 41. When the rotary shaft part 42 is rotated about the central axis by the rotative power transmitted from the drive unit 13, the circular plate part 41 connected to the rotary shaft part 42 is rotated about the central axis L. The rotary disk 40 is thus rotated about the central axis L by the rotative power from the drive unit 13.

As shown in FIGS. 2, 3, and 5, the fixed disk 50 includes the circular plate part 51 and cylindrical parts 52.

The circular plate part 51 has a circular plate-like shape and includes fixed-disk ports 70 each extending through the circular plate part 51 in the axial direction. Herein, the circular plate part 51 is provided with three fixed-disk ports 70. As the three fixed-disk ports 70, as shown in FIGS. 2 and 5, a first fixed-disk port 71, a second fixed-disk port 72, and a third fixed-disk port 73 are provided. The fixed-disk ports 70 (i.e., the first fixed-disk port 71, second fixed-disk port 72, and third fixed-disk port 73) are one example of a “port of the first fixed member” of the disclosure.

The cylindrical parts 52 are connected to the circular plate part 51 and extend from the circular plate part 51 in the axial direction so as to each surround the corresponding one of the fixed-disk ports 70. Herein, three cylindrical parts 52 are formed in one-to-one correspondence with the three fixed-disk ports 70.

The drive unit 13 is provided with a motor (not shown) to supply rotative power to the rotary shaft part 42 of the rotary disk 40.

In the flow path switching device 1 configured as above, the fixed-disk inflow ports 70, which are connected to the inflow ports 20, the rotary-disk communication paths 60, and the outflow ports 30 are communicated to form flow paths through which fluid flows. The flow path switching device 1 is configured such that the drive unit 13 rotationally drives the rotary disk 40 about the central axis L to switch combinations of the fixed-disk inflow ports 70 and the outflow ports 30, which are communicated through the rotary-disk communication paths 60, to switch flow path patterns for fluid flow (hereinafter, referred to as a “flow path pattern”). Examples of switching the flow path patterns will be described later.

The flow path switching device 1 is not limited to the six-way valve and may be another multiple-way valve, such as a three-way valve and a four-way valve.

Further, as shown in FIG. 3, seal members 81 are provided between the housing 11 and the rotary disk 40 and between the rotary disk 40 and the fixed disk 50. The seal members 81 externally seal the flow paths formed between the fixed-disk ports 70 and the rotary-disk communication paths 60 communicated with the corresponding fixed-disk ports 70 and the flow paths formed between the outflow ports 30 and the rotary-disk communication paths 60 communicated with the corresponding outflow ports 30.

Further, disk holding springs 82 are provided between the circular plate part 51 of the fixed disk 50 and the housing 11. The stress caused by the pressing force of the disk holding springs 82 acts on the circular plate part 51 of the fixed disk 50. A total of three disk holding springs 82 are placed to individually surround the three cylindrical parts 52 of the fixed disk 50.

In addition, lip seals 83 for securing the sealing performance of the corresponding fixed-disk ports 70 are provided between the cylindrical parts 52 of the fixed disk 50 and the housing 11.

### <Switching of Flow Path Patterns>

### First Embodiment

A first embodiment will be described first.

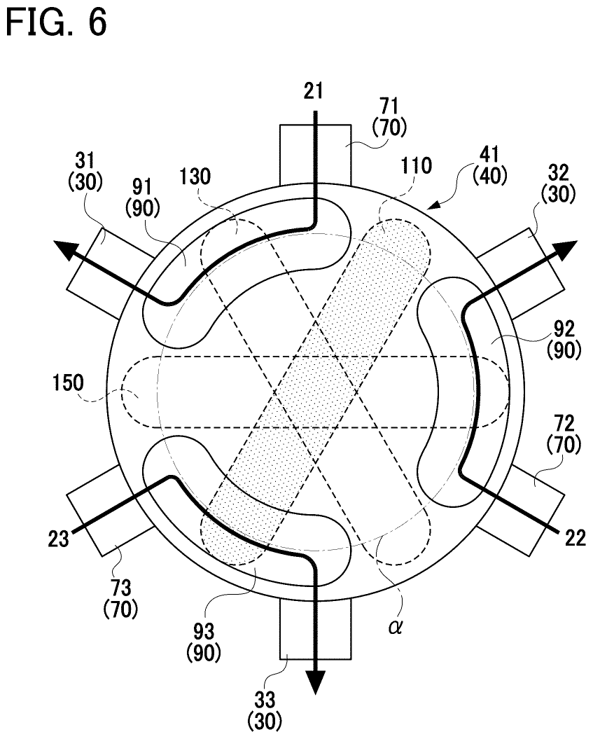

As shown in FIG. 6, when viewed in the axial direction of the circular plate part 41 of the rotary disk 40, a plurality of the fixed-disk ports 70 (three in the example shown in FIG. 6) and a plurality of the outflow ports 30 (three in the example shown in FIG. 6) are alternately arranged at equal intervals and at positions offset from each other in the circumferential direction of the circular plate part 41.

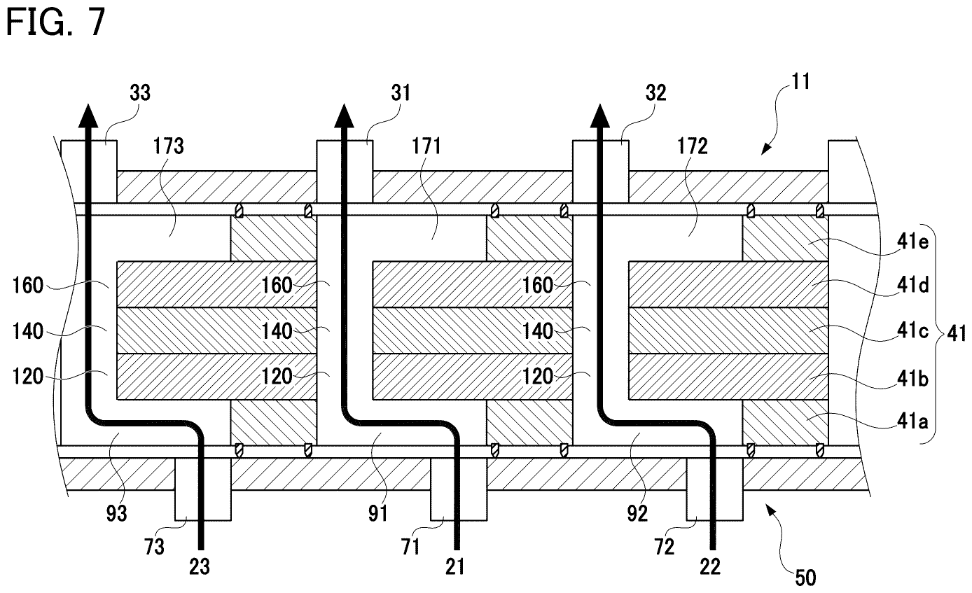

In this example, the circular plate part 41 of the rotary disk 40 is composed of a plurality of circular plate members stacked in layers. Specifically, as shown in FIG. 7, the circular plate part 41 is formed of a 1^{st}-layer circular plate member 41a, a 2^{nd}-layer circular plate member 41b, a 3^{rd}-layer circular plate member 41c, a 4^{th}layer circular plate member 41d, and a 5^{th}-layer circular plate member 41e, which are stacked in their axial direction. Each of these five circular plate members 41a to 41e is a molded component made of resin, formed with part of the rotary-disk communication paths 60.

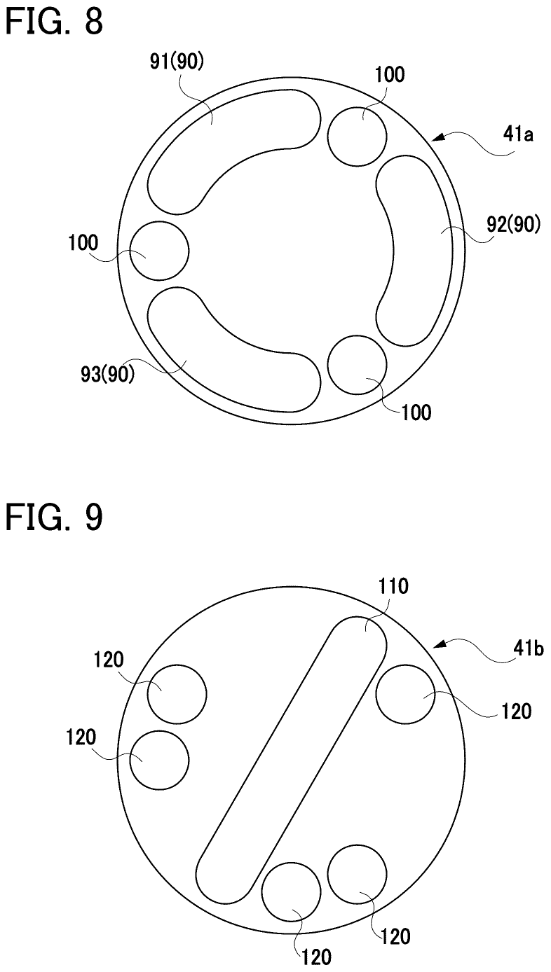

As shown in FIG. 8, the 1^{st}-layer circular plate member 41a has three adjacent-port communication paths 90 and three communication holes 100, which are formed as part of the rotary-disk communication paths 60 and extending through the 1^{st}-layer circular plate member 41a in the axial direction. Herein, the adjacent-port communication paths 90 are communication paths for allowing communication between the fixed-disk ports 70 and the outflow ports 30, which are located at positions adjacent to each other in the circumferential direction of the rotary disk 40 when viewed in the axial direction of the rotary disk 40, as will be described in detail later. The 1^{st}-layer circular plate member 41a is provided, as the three adjacent-port communication paths 90, with a first adjacent-port communication path 91, a second adjacent-port communication path 92, and a third adjacent-port communication path 93. On the lower surface (not shown) of the 1^{st}-layer circular plate member 41a is provided with the seal members 81.

The communication holes 100 are communication paths for allowing communication between the fixed-disk ports 70 and adjacent-port communication paths 170 mentioned later in cooperation with a first opposite-port communication path 110, communication holes 120, a second opposite-port communication path 130, communication holes 140, a third opposite-port communication path 150, and communication holes 160, which will be described later.

As shown in FIG. 9, the 2^{nd}-layer circular plate member 41b has the first opposite-port communication path 110 and five communication holes 120, which are formed extending through the 2^{nd}-layer circular plate member 41b in its axial direction, as part of the rotary-disk communication paths 60. Herein, the first opposite-port communication path 110 is a communication path for allowing communication between the fixed-disk port 70 and the outflow port 30, which are located at positions opposite each other in the radial direction of the rotary disk 40 when viewed in the axial direction of the rotary disk 40, as will be described in detail later.

Three of the five communication holes 120 are communication path for allowing communication between the adjacent-port communication paths 90 and the adjacent-port communication paths 170 which will be mentioned later in cooperation with the communication holes 140 and the communication holes 160 which will be mentioned later. Further, other two communication holes 120 are communication paths that are communicated with the second opposite-port communication path 130 and the third opposite-port communication path 150, which will be described later, and used for allowing communication between the fixed-disk ports 70 and the adjacent-port communication paths 170 in cooperation with the communication holes 100, second opposite-port communication path 130, communication holes 140, third Opposite-port communication path 150, and communication holes 160.

As shown in FIG. 10, the 3^{rd}-layer circular plate member 41c has the second opposite-port communication path 130 and five communication holes 140, which are formed extending through the 3^{rd}-layer circular plate member 41c in its axial direction, as part of the rotary-disk communication paths 60. Herein, the second opposite-port communication path 130 is a communication path for allowing communication between the fixed-disk ports 70 and the outflow ports 30, which are located opposite each other in the radial direction of the rotary disk 40 when viewed in the axial direction of the rotary disk 40, as will be described in detail later.

Three of the five communication holes 140 are communication paths for allowing communication between the adjacent-port communication paths 90 and the adjacent-port communication paths 170 in cooperation with the communication holes 120 and the communication holes 160. Further, other two communication holes 140 are communication paths that are communicated with the first opposite-port communication path 110 and the third opposite-port communication path 150, and used for allowing communication between the fixed-disk ports 70 and the adjacent-port communication paths 170 in cooperation with the communication holes 100, first opposite-port communication path 110, communication holes 120, third opposite-port communication path 150, and communication holes 160.

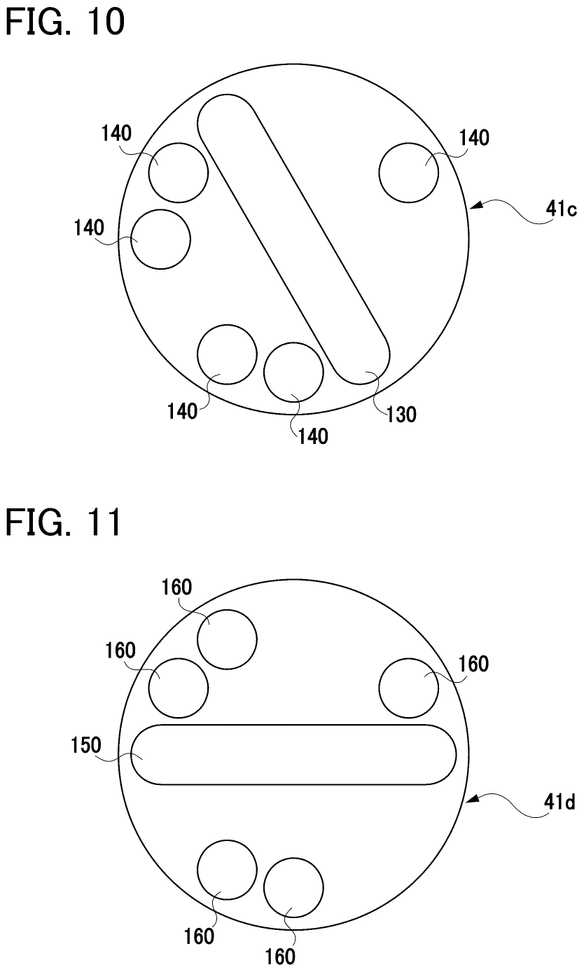

As shown in FIG. 11, the 4^{th}-layer circular plate member 41d has the third opposite-port communication path 150 and five communication holes 160, which are formed extending through the 4^{th}-layer circular plate member 41d in its axial direction, as part of the rotary-disk communication paths 60. Herein, the third opposite-port communication path 150 is a communication path for allowing communication between the fixed-disk ports 70 and the outflow ports 30, which are located at positions opposite each other in the radial direction of the rotary disk 40 when viewed in the axial direction of the rotary disk 40, as will be described in detail later.

Three of the five communication holes 160 are communication paths for allowing communication between the adjacent-port communication paths 90 and the adjacent-port communication paths 170 in cooperation with the communication holes 120 and the communication holes 140. Further, other two communication holes 160 are communication paths that are communicated with the first opposite-port communication path 110 and the second opposite-port communication path 130, and used for allowing communication between the fixed-disk ports 70 and the adjacent-port communication paths 170 in cooperation with the communication hole 100, first opposite-port communication paths 110, communication holes 120, second opposite-port communication path 130, and communication holes 140.

As shown in FIG. 12, the 5th-layer circular plate member 41e has three adjacent-port communication paths 170, which are formed extending through the 5^{th}-layer circular plate member 41e in its axial direction, as part of the rotary-disk communication paths 60. Herein, the adjacent-port communication paths 170 are communication paths for allowing communication between the fixed-disk ports 70 and the outflow ports 30, which are located at positions adjacent to each other in the circumferential direction of the rotary disk 40 when viewed in the axial direction of the rotary disk 40. The 5^{th}-layer circular plate member 41e is provided, as the three adjacent-port communication paths 170, with a first adjacent-port communication path 171, a second adjacent-port communication path 172, and a third adjacent-port communication path 173. The rotary shaft part 42 is connected to and the seal members 81 are placed on the upper surface of this 5^{th}-layer circular plate member 41e.

In the present example, as described above, the rotary disk 40 includes three adjacent-port communication paths 90 and three adjacent-port communication paths 170, as part of the rotary-disk communication paths 60.

Furthermore, the rotary disk 40 includes the first opposite-port communication path 110, the second opposite-port communication path 130, and the third opposite-port communication path 150 (hereinafter, also referred to as “three Opposite-port communication paths 110, 130, 150”) in addition to the adjacent-port communication paths 90 and the adjacent-port communication paths 170, as part of the rotary-disk communication paths 60.

These three opposite-port communication paths 110, 130, 150 are placed without interfering with each other in the axial direction of the circular plate part 41 of the rotary disk 40 while intersecting with each other in the radial direction of the circular plate part 41 of the rotary disk 40.

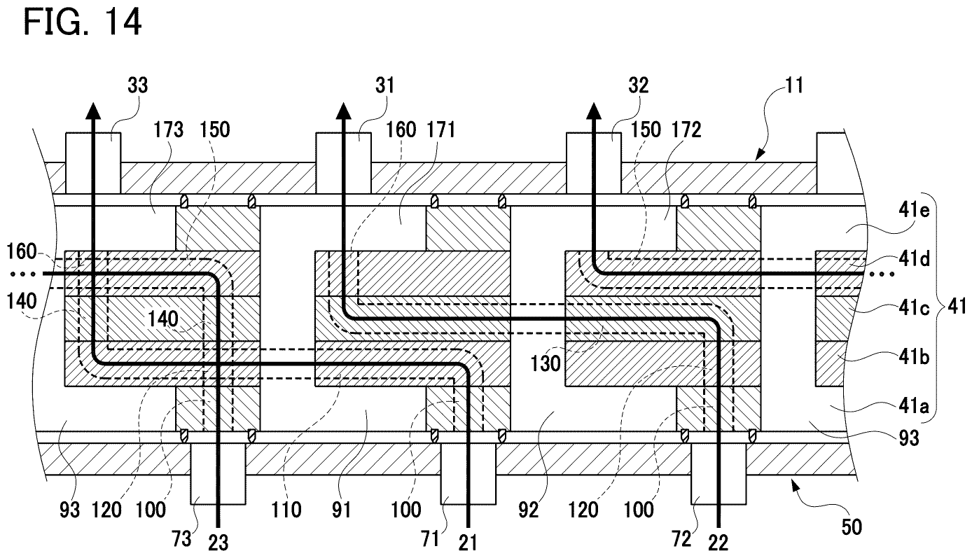

Specifically, the three opposite-port communication paths 110, 130, 150 are formed individually in the 2^{nd}-layer circular plate member 41b, 3^{rd}-layer circular plate member 41c, and 4^{th}-layer circular plate member 41d and located in different positions in the axial direction of the rotary disk 40 (see FIG. 14 mentioned later), while intersecting with each other in the radial direction of the rotary disk 40.

In the present example, with the rotary disk 40 configured as above, the flow path patterns can be switched as follows in the present example. In FIG. 6, the first opposite-port communication path 110 is hatched with dots to make it easier to distinguish the shapes of the three opposite-port communication paths 110, 130, 150 from one another.

In the first flow path pattern, as shown in FIGS. 6 and 7, the first adjacent-port communication path 91 allows communication between the first fixed-disk port 71 and the first outflow port 31. Concretely, the first fixed-disk port 71 communicated with the first inflow port 21 is brought into communication with the first outflow port 31 via the first adjacent-port communication path 91, communication hole 120, communication hole 140, communication hole 160, and first adjacent-port communication path 171.

The second adjacent-port communication path 92 allows communication between the second fixed-disk port 72 and the second outflow port 32. Concretely, the second fixed-disk port 72 communicated with the second inflow port 22 is brought into communication with the second outflow port 32 through the second adjacent-port communication path 92, communication hole 120, communication hole 140, communication hole 160. and second adjacent-port communication path 172.

Further, the third adjacent-port communication path 93 allows communication between the third fixed-disk port 73 and the third outflow port 33. Concretely, the third fixed-disk port 73 communicated with the third inflow port 23 is brought into communication with the third outflow port 33 through the third adjacent-port communication path 93, communication hole 120, communication hole 140, communication hole 160, and third adjacent-port communication path 173.

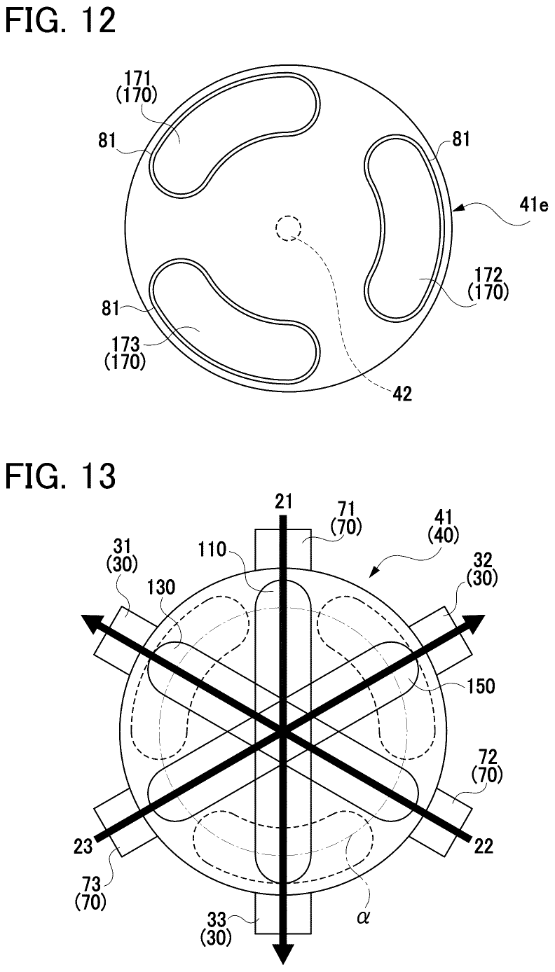

Next, in the second flow path pattern switched from the first flow path pattern by rotating the circular plate part 41 of the rotary disk 40, 30° counterclockwise, as shown in FIGS. 13 and 14, the first opposite-port communication path 110 allows communication between the first fixed-disk port 71 and the third outflow port 33. Concretely, the first fixed-disk port 71 communicated with the first inflow port 21 is brought into communication with the third outflow port 33 through the communication hole 100, first opposite-port communication path 110, communication hole 140, communication hole 160, and third adjacent-port communication path 173.

Further, the second opposite-port communication path 130 allows communication between the second fixed-disk port 72 and the first outflow port 31. Concretely, the second fixed-disk port 72 communicated with the second inflow port 22 is brought into communication with the first outflow port 31 through the communication hole 100, communication hole 120, second opposite-port communication path 130, communication hole 160, and adjacent-port communication path 170.

Furthermore, the third opposite-port communication path 150 allows communication between the third fixed-disk port 73 and the second outflow port 32. Concretely, the third fixed-disk port 73 communicated with the third inflow port 23 is brought into communication with the second outflow port 32 through the communication hole 100, communication hole 120, communication hole 140, third opposite-port communication path 150, and second adjacent-port communication path 172.

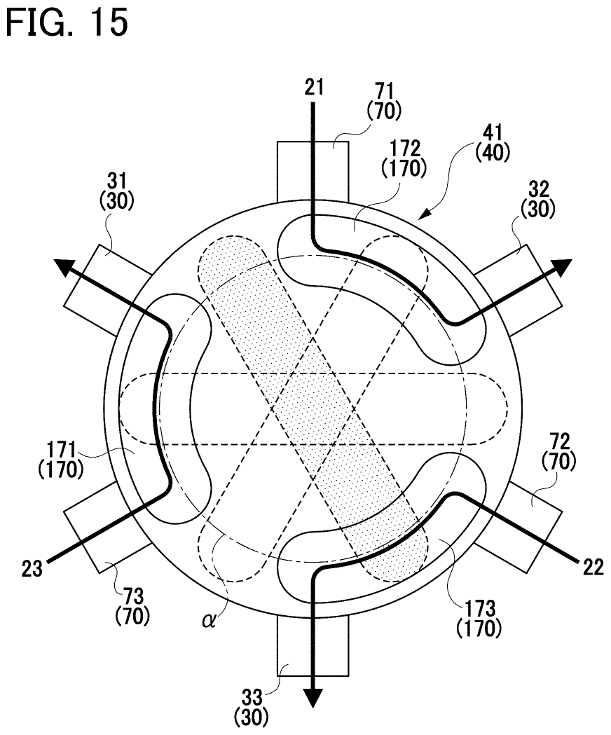

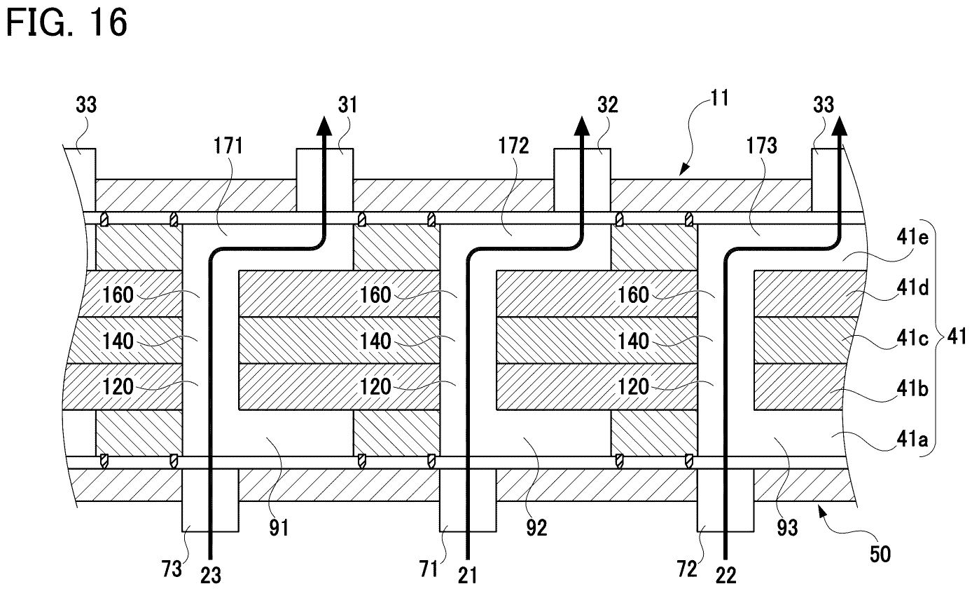

Next, in the third flow path pattern switched from the second flow path pattern by rotating the circular plate part 41 of the rotary disk 40, 30° counterclockwise, as shown in FIGS. 15 and 16, the second adjacent-port communication path 172 allows the first fixed-disk port 71 and the second outflow port 32. Concretely, the first fixed-disk port 71 communicated with the first inflow port 21 is brought into communication with the second outflow port 32 through the second adjacent-port communication path 92, communication hole 120, communication hole 140, communication hole 160, and second adjacent-port communication path 172.

Further, the third adjacent-port communication path 173 allows communication between the second fixed-disk port 72 and the third outflow port 33. Concretely, the second fixed-disk port 72 communicated with the second inflow port 22 is brought into communication with the third outflow port 33 through the third adjacent-port communication path 93, communication hole 120, communication hole 140, communication hole 160, and third adjacent-port communication path 173.

Furthermore, the first adjacent-port communication path 171 allows communication between the third fixed-disk port 73 and the first outflow port 31. Concretely, the third fixed-disk port 73 communicated with the third inflow port 23 is brought into communication with the first outflow port 31 through the first adjacent-port communication path 91, communication hole 120, communication hole 140, communication hole 160, and first adjacent-port communication path 171.

By use of the flow path switching device 1 that can switch flow path patterns as above, a temperature adjusting system 201 mounted on a vehicle can warm or cool a battery 211 and a PCU 212 as follows.

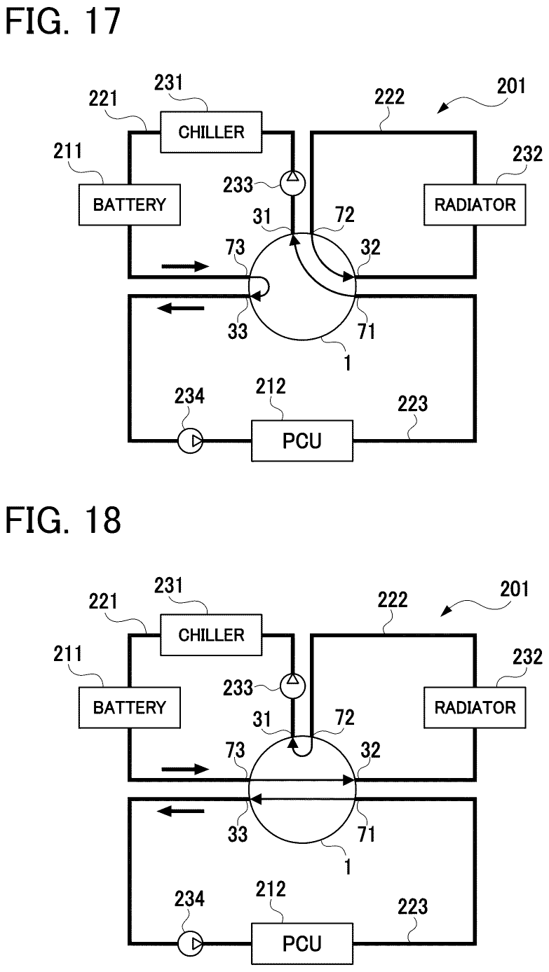

The temperature adjusting system 201 includes a first flow path 221, a second flow path 222, and a third flow path 223, as flow paths through which a fluid (e.g., coolant water) flows, as shown in FIG. 17. In the first flow path 221, the battery 211, a chiller 231, and a check valve 233 are provided. In the second flow path 222, a radiator 232 is provided. In the third flow path 223, further, the PCU 212 and a check valve 234 are provided. The flow path switching device 1 is connected to the first flow path 221, second flow path 222, and third flow path 223.

In the temperature adjusting system 201 configured as above, the flow path switching device 1 is switched to the first flow path pattern at the start of running (at warm-up) at extremely low temperatures, as shown in FIG. 17. Accordingly, the PCU 212 storages heat and warms up, the battery 211 warms up by the heat stored in the PCU 212, a vehicle compartment is heated by the heat stored in the PCU 212, the heat generated by the battery 211, and heaters (not shown).

At the time of rapid charging (at the stop of running), the flow path switching device 1 is switched to the second flow path pattern, as shown in FIG. 18. Accordingly, the battery 211 can be cooled by the chiller 231 and the radiator 232.

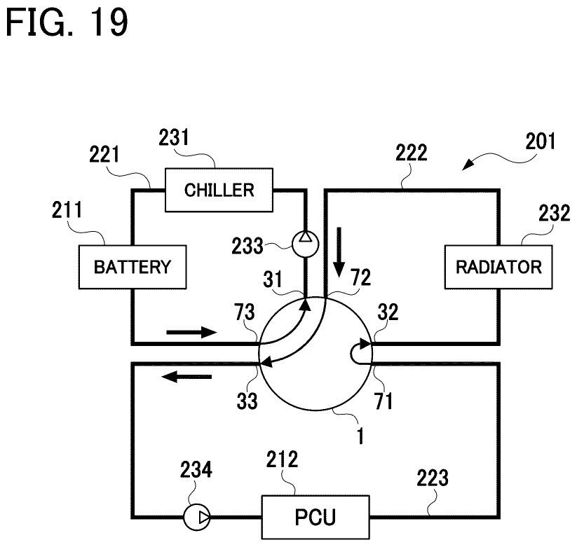

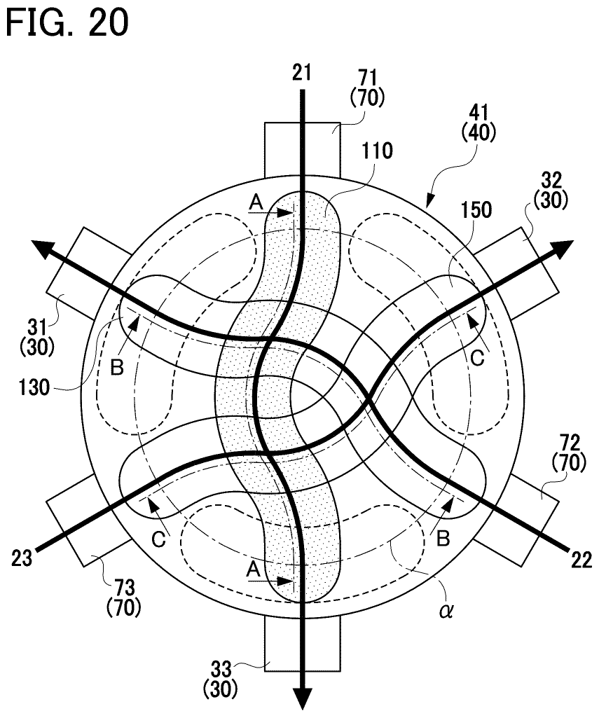

At the time of normal running (after warm-up), the flow path switching device 1 is switched to the third flow path pattern, as shown FIG. 19. Accordingly, the battery 211 can be cooled by the chiller 231, and the PCU 212 can be cooled by the radiator 232.

In the present example, as the rotary-disk communication paths 60, the adjacent-port communication paths 90, 170 and the opposite-port communication paths 110, 130, 150 are provided.

Consequently, the flow path switching device I can also be switched not only to the flow path patterns formed by the opposite-port communication paths 110, 130, 150, but also to the flow path patterns formed by the adjacent-port communication paths 90, 170. This allows the number of switchable flow path patterns to be increased. Therefore, the flow path switching device 1 can be switched to many flow path patterns.

Moreover, the three opposite-port communication paths 110, 130, 150 are formed respectively in the 2^{nd}-layer circular plate member 41b, 3^{rd}-layer circular plate member 41c, and 4^{th}-layer circular plate member 41d, at different positions in the axial direction of the rotary disk 40, while intersecting with each other in the radial direction of the rotary disk 40.

Thus, the three opposite-port communication paths 110, 130, 150 can be provided without interfering with each other in the axial direction of the rotary disk 40. This enables the formation of flow path patterns with the three opposite-port communication paths 110, 130, 150.

The rotary disk 40 is formed of five circular plate members 41a to 41e stacked on top of each other. Each of these five circular plate members 41a to 41e is a molded component made of resin, formed with a part of the rotary-disk communication paths 60.

Accordingly, the rotary-disk communication paths 60 of complicated shapes can be easily formed in the rotary disk 40. Thus, the rotary-disk communication paths 60 of various shapes can be realized.

### Second Embodiment

Next, a second embodiment will be described, focusing on differences from the first example and omitting identical points to those in the first example.

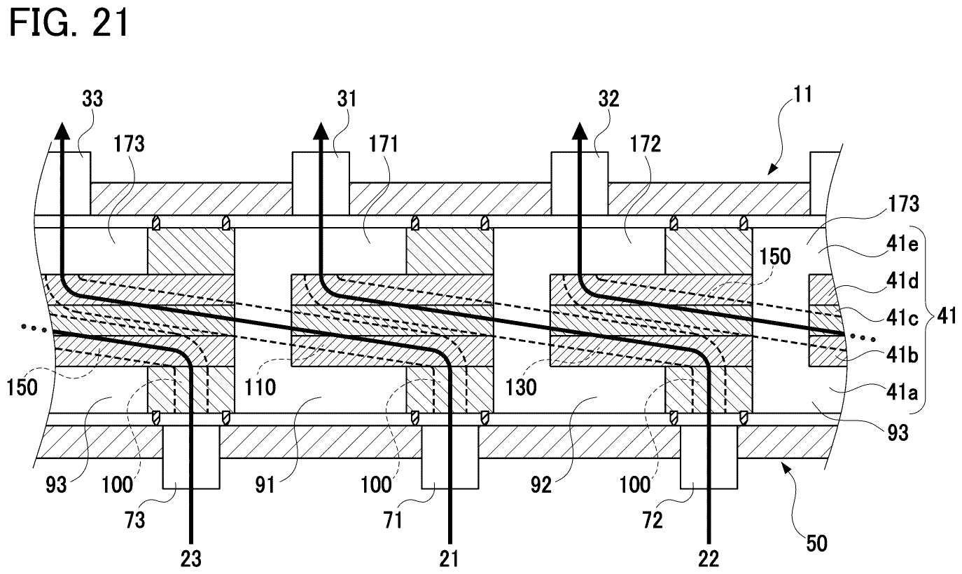

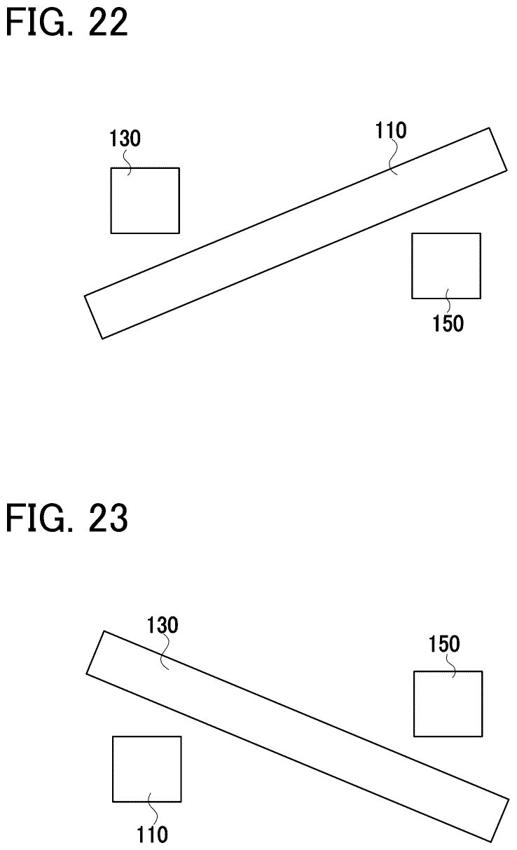

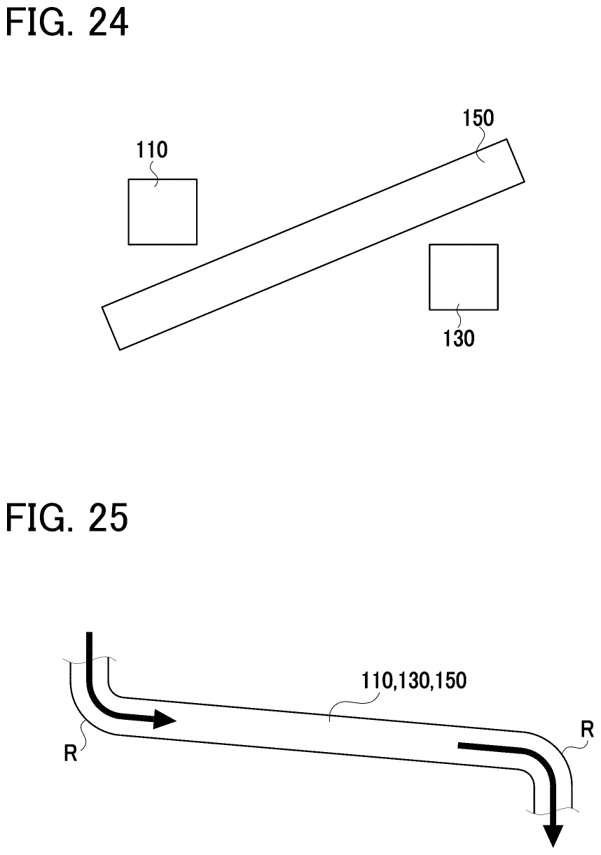

In the present example, as shown in FIGS. 20 and 21, the three opposite-port communication paths 110, 130, 150 are each formed in a spiral shape. At the location where the opposite-port communication paths intersect with each other, as shown in FIGS. 22 to 24, the opposite-port communication paths are placed at different heights from each other to avoid interference of the opposite-port communication paths in the axial direction.

In FIG. 20, the first opposite-port communication path 110 is hatched with dots to make it easier to distinguish the shapes of the three opposite-port communication paths 110, 130, 150 from one another.

In the present example, as above, the three opposite-port communication paths 110, 130, 150 are inclined toward the axial direction of the rotary disk 40 without interfering with each other in the axial direction of the rotary disk 40 while intersecting with each other in the radial direction of the rotary disk 40, as shown in FIGS. 21 to 25.

Accordingly, the flow path patterns can be formed by use of the three opposite-port communication paths 110, 130, 150 and the fluid flowing through the three opposite-port communication paths 110, 130, 150 is allowed to smoothly flow along the inclination, so that pressure loss of the fluid can be reduced. Further, the thickness (i.e., the width in the axial direction) of the rotary disk 40 can be reduced, downsizing the flow path switching device 1.

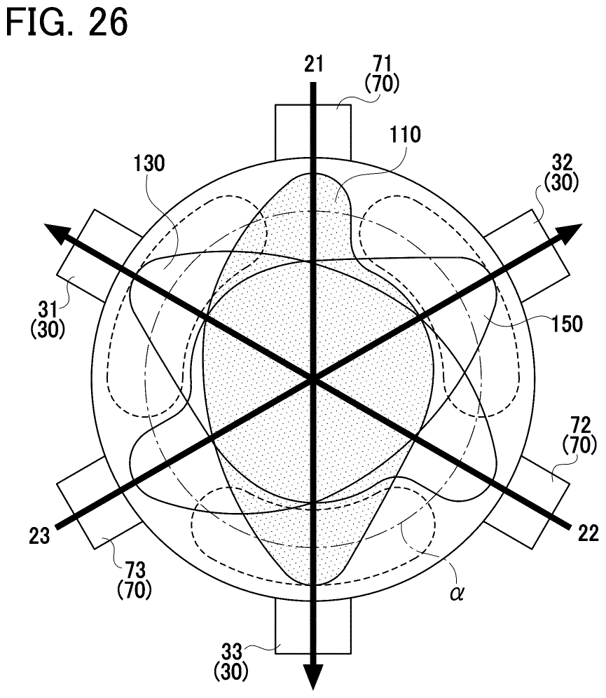

As shown in FIG. 25, moreover, the three opposite-port communication paths 110, 130, 150 are each provided with a rounded portion (indicated by “R” in the figure) at its inlet and outlet. This allows the fluid flowing through the three opposite-port communication paths 110, 130, 150 to smoothly flow along the inclination more effectively.

### Third Embodiment

Next, a third embodiment will be described, focusing on differences from the first and second embodiments, and omitting identical points to those in the first and second embodiments.

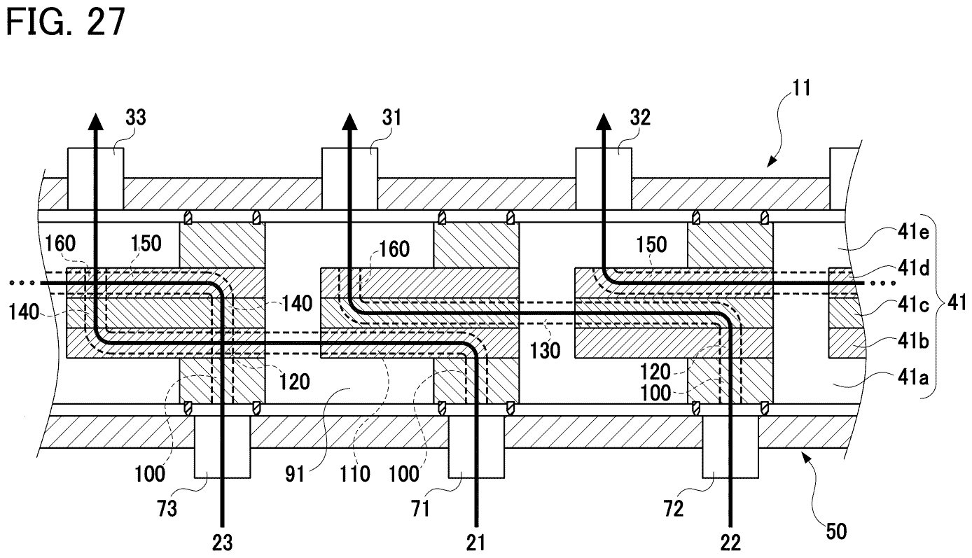

In this example, as shown in FIGS. 26 and 27, the three opposite-port communication paths 110, 130, 150 are each formed in a flat shape extending in the radial direction of the rotary disk 40. This can reduce the thickness of the rotary disk 40 while ensuring each flow-path cross-sectional area of the three opposite-port communication paths 110, 130, 150. This configuration allows for downsizing of the flow path switching device 1 while ensuring the flow rate of a fluid flowing through the three opposite-port communication paths 110, 130, 150. These three opposite-port communication paths 110, 130, 150 are formed so as not to overlap the communication holes 120, 140, 160. In FIG. 26, the first opposite-port communication path 110 is hatched with dots to make it easier to distinguish the shapes of the three opposite-port communication paths 110, 130, 150.

The foregoing embodiments are mere examples and give no limitation to the disclosure. The disclosure may be embodied in other specific forms without departing from the essential characteristics thereof.

For example, the rotary disk 40 only has to include a plurality of adjacent-port communication paths and a plurality of opposite-port communication paths, which may be two, four, or more. Further, the fixed-disk ports 70 and the outflow ports 30 only have to be provided as multiple ports, which may be two, four, or more. Further, the rotary disk 40 only has to be formed of a plurality of circular plate members stacked in layers, and may be formed of two to four, six, or more circular plate members stacked in layers.

### REFERENCE SIGNS LIST

1 Flow path switching device
11 Housing
12 Valve body unit
20 Inflow port
21 First inflow port
22 Second inflow port
23 Third inflow port
30 Outflow port
31 First outflow port
32 Second outflow port
33 Third outflow port
40 Rotary disk
41 Circular plate part
41a 1^{st} circular plate member
41b 2^{nd} circular plate member
41c 3^{rd} circular plate member
41d 4^{th} circular plate member
41e 5^{th} circular plate member
50 Fixed disk
60 Rotary-disk communication path
70 Fixed-disk port
71 First fixed-disk port
72 Second fixed-disk port
73 Third fixed-disk port
90 Adjacent-port communication path
91 First adjacent-port communication path
92 Second adjacent-port communication path
93 Third adjacent-port communication path
110 First opposite-port communication path
130 Second opposite-port communication path
150 Third opposite-port communication path
170 Adjacent-port communication path
171 First adjacent-port communication path
172 Second adjacent-port communication path
173 Third adjacent-port communication path
L Central axis

1. A flow path switching device comprising:
a first fixed member ;
a second fixed member; and
a rotary member having a circular plate shape and provided between the first fixed member and the second fixed member,
the first fixed member including a plurality of ports and the second fixed member including a plurality of ports,
the rotary member being provided with a communication path to allow communication between the ports of the first fixed member and the ports of the second fixed member,
the rotary member being rotated about a central axis of the circular plate shape to switch combinations of the ports of the first fixed member and the ports of the second fixed member, which are communicated through the communication path, to switch a flow path pattern through which a fluid flows,
wherein the communication path includes:
an adjacent-port communication path for allowing communication between the port of the first fixed member and the port of the second fixed member, the ports being provided at positions adjacent to each other in a circumferential direction of the rotary member when viewed in an axial direction of the rotary member; and
an opposite-port communication path for allowing communication between the port of the first fixed member and the port of the second fixed member, the ports being provided at positions opposite each other in a radial direction of the rotary member when viewed in the axial direction of the rotary member.

2. The flow path switching device according to claim 1, wherein the opposite-port communication path includes a plurality of opposite-port communication paths that are provided in different positions from each other in the axial direction of the rotary member, while intersecting with each other in the radial direction of the rotary member.

3. The flow path switching device according to claim 1, wherein the opposite-port communication path includes a plurality of opposite-port communication paths that are inclined without interfering with each other in the axial direction of the rotary member, while intersecting with each other in the radial direction of the rotary member.

4. The flow path switching device according to claim 2, wherein the opposite-port communication paths are each formed in a flat shape extending in the radial direction of the rotary member.

5. The flow path switching device according to claim 1, wherein
the rotary member is composed of a plurality of circular plate members stacked in layers, and
each of the plurality of circular plate members is a molded component made of resin, formed with a part of the communication path.

6. The flow path switching device according to claim 1, wherein
the ports of the first fixed member and the ports of the second fixed member are provided as three or more ports, the ports of the first fixed member being provided at positions offset from the ports of the second fixed member in a circumferential direction of the rotary member, and
the opposite-port communication path is provided as three or more opposite-port communication paths without interfering with each other in the axial direction of the rotary member, while intersecting with each other in the radial direction of the rotary member.

7. The flow path switching device according to claim 2, wherein
the rotary member is composed of a plurality of circular plate members stacked in layers, and
each of the plurality of circular plate members is a molded component made of resin, formed with a part of the communication path.

8. The flow path switching device according to claim 3, wherein
the rotary member is composed of a plurality of circular plate members stacked in layers, and
each of the plurality of circular plate members is a molded component made of resin, formed with a part of the communication path.

9. The flow path switching device according to claim 4, wherein
the rotary member is composed of a plurality of circular plate members stacked in layers, and
each of the plurality of circular plate members is a molded component made of resin, formed with a part of the communication path.

10. The flow path switching device according to claim 2, wherein
the ports of the first fixed member and the ports of the second fixed member are provided as three or more ports, the ports of the first fixed member being provided at positions offset from the ports of the second fixed member in a circumferential direction of the rotary member, and
the opposite-port communication paths are provided as three or more opposite-port communication paths without interfering with each other in the axial direction of the rotary member, while intersecting with each other in the radial direction of the rotary member.

11. The flow path switching device according to claim 3, wherein
the ports of the first fixed member and the ports of the second fixed member are provided as three or more ports, the ports of the first fixed member being provided at positions offset from the ports of the second fixed member in a circumferential direction of the rotary member, and
the opposite-port communication paths are provided as three or more opposite-port communication paths without interfering with each other in the axial direction of the rotary member, while intersecting with each other in the radial direction of the rotary member.

12. The flow path switching device according to claim 4, wherein
the ports of the first fixed member and the ports of the second fixed member are provided as three or more ports, the ports of the first fixed member being provided at positions offset from the ports of the second fixed member in a circumferential direction of the rotary member, and
the opposite-port communication paths are provided as three or more opposite-port communication paths without interfering with each other in the axial direction of the rotary member, while intersecting with each other in the radial direction of the rotary member.

13. The flow path switching device according to claim 5, wherein
the ports of the first fixed member and the ports of the second fixed member are provided as three or more ports, the ports of the first fixed member being provided at positions offset from the ports of the second fixed member in a circumferential direction of the rotary member, and
the opposite-port communication paths are provided as three or more opposite-port communication paths without interfering with each other in the axial direction of the rotary member, while intersecting with each other in the radial direction of the rotary member.
